(19) United States
(12) Patent Application Publication
(10) Pub. No.: US 2010/0295750 A1
(43) Pub. Date: Nov. 25, 2010

(54) ANTENNA FOR DIVERSITY APPLICATIONS

(75) Inventors: Shie Ping Terence See, Singapore (SG); Zhining Chen, Singapore (SG)

Correspondence Address: AXIS INTELLECTUAL CAPITAL PTE LTD., 21 Science Park Road, #03-01 The Aquarius Science Park II, SINGAPORE, 117628, SG

(73) Assignee: Agency for Science, Technology and Research, Singapore (SG)

(21) Appl. No.: 12/734,083

(22) PCT Filed: Oct. 9, 2008
(86) PCT No.: PCT/SG2008/000388

§ 371 Date: Jul. 8, 2010

Related U.S. Application Data
(60) Provisional application No. 60/978,429, filed on Oct. 9, 2007.

(51) Int. Cl. H01Q 21/24

(52) U.S. Cl. 343/893

(57) ABSTRACT

An antenna for ultra-wideband applications is disclosed. The antenna has a first radiating element shaped for defining a first notch, the first radiating element having a first feeding structure. The antenna further has a second radiating element operatively couplable to the first radiating element and shaped for defining a second notch. The second radiating element having a second feeding structure, the first and second feeding structures being substantially orthogonal to each other and the first and second radiating elements having an inter-displacement. More specifically, the first radiating element and the first feeding structure is substantially symmetrical to the second radiating element and the second feeding structure respectively about a line of symmetry passing through the inter-displacement between the first and second radiating elements for achieving orthogonal polarization and radiating pattern diversity between the first and second radiating elements.

### CROSS-REFERENCE TO RELATED APPLICATION

This application claims the benefit of U.S. provisional application Ser. No. 60/978,429, filed Oct. 9, 2007 and entitled “Antennas For Diversity Applications” incorporated herein by reference in its entirety.

### FIELD OF INVENTION

The invention relates generally to antennas. In particular, it relates to ultra-wideband antennas for diversity applications.

### BACKGROUND

Ultra-wideband (UWB) technology is now widely used in wireless communication systems. Wireless UWB systems have very wide operating bandwidth and fast data transfer rates. One such system is able to support a data transfer rate of 480 Mbps within an operating range of 3 m or 110 Mbps within an operating range of 10 m.

The demand for wireless communication device miniaturization has created a need for wireless UWB systems that are sufficiently small to be contained in a USB thumb drive. However, antennas used in conventional wireless UWB systems require a large ground plane to achieve the desired UWB operating performance.

Therefore, a space limitation exist in conventional UWB systems to be implemented in a device as small as a USB thumb drive while improving impedance matching and radiation performance across a broad bandwidth.

There is therefore a need for a UWB antenna which is sufficiently small while improving impedance matching and radiation performance across a broad bandwidth for use in small portable UWB devices.

### SUMMARY

Embodiments of the invention are disclosed hereinafter for ultra-wideband (UWB) applications for improving impedance matching and radiation performance across a broad bandwidth and sufficiently small for use in small portable UWB devices.

In accordance with one aspect of the invention, there is disclosed an antenna for ultra-wideband applications. The antenna has a first radiating element shaped for defining a first notch, the first radiating element having a first feeding structure. The antenna further has a second radiating element operatively couplable to the first radiating element and shaped for defining a second notch. The second radiating element having a second feeding structure, the first and second feeding structures being substantially orthogonal to each other and the first and second radiating elements having an inter-displacement. More specifically, the first radiating element and the first feeding structure is substantially symmetrical to the second radiating element and the second feeding structure respectively about a line of symmetry passing through the inter-displacement between the first and second radiating elements for achieving orthogonal polarization and radiating pattern diversity between the first and second radiating elements.

In accordance with another aspect of the invention, there is disclosed a method for configuring an antenna for UWB applications. The method involves an initial step of providing a first radiating element shaped for defining a first notch, the first radiating element having a first feeding structure. The method then involves the step of providing a second radiating element operatively couplable to the first radiating element and shaped for defining a second notch. The second radiating element having a second feeding structure, the first and second feeding structures being substantially orthogonal to each other and the first and second radiating elements having an inter-displacement. More specifically, the first radiating element and the first feeding structure is substantially symmetrical to the second radiating element and the second feeding structure respectively about a line of symmetry passing through the inter-displacement between the first and second radiating elements for achieving orthogonal polarization and radiating pattern diversity between the first and second radiating elements.

### BRIEF DESCRIPTION OF DRAWINGS

Embodiments of the invention are described in detail hereinafter with reference to the drawings, in which:

FIGS. 1a to 1d are schematic views of an antenna according to a first embodiment of the invention;

FIG. 2 is a graph showing measured results of the return loss and isolation characteristics of the antenna 100 of FIG. 1a;

FIGS. 3a to 3c are images showing current distribution during operation of antenna of FIG. 1a at 3, 4 and 5 GHz respectively;

FIGS. 4a to 4c are graphs showing measured radiation patterns across the bandwidth of the antenna of FIG. 1a over three main planes;

FIGS. 5a and 5b are schematic views of the antenna according to a second embodiment of the invention;

FIG. 6 is a graph showing measured and simulated results of the impedance matching characteristics of the antenna 100 of FIG. 5a;

FIGS. 7a to 7c are graphs showing measured radiation patterns across the bandwidth of the antenna of FIG. 5a over three main planes;

FIG. 8 is a schematic view showing important dimensional parameters of the antenna of FIG. 5a; and

FIG. 9 shows various examples of the geometrical shape of radiating elements of the antenna of FIGS. 1a and 5a.

### DETAILED DESCRIPTION

With reference to the drawings, antennas having substantially good impedance matching and radiation performance across a broad bandwidth and sufficiently small for use in small portable ultra-wideband (UWB) devices according to embodiments of the invention are disclosed.

Various conventional antennas have been previously proposed for UWB applications. However, some of these conventional UWB antennas require ground planes for operation that are not suitable for use in small portable UWB devices.

For purposes of brevity and clarity, the description of the invention is limited hereinafter to UWB applications. This, however, does not preclude embodiments of the invention from other applications that require similar operating performance as the UWB applications. The functional principles fundamental to the embodiments of the invention remain the same throughout the various embodiments.

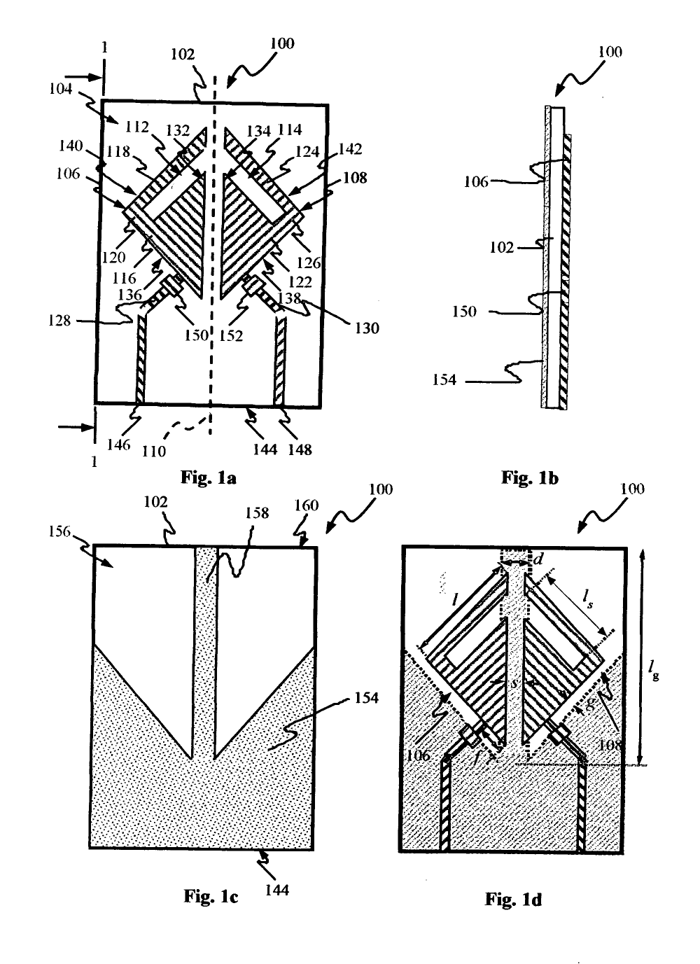

Embodiments of the invention are disclosed hereinafter for UWB applications having substantially good impedance matching and radiation performance across a broad bandwidth and sufficiently small for use in small portable UWB devices. Embodiments of the invention are described in greater detail in accordance with FIGS. 1a to 9, and the drawings hereinafter, wherein like elements are identified with like reference numerals.

FIGS. 1a to 1d show the geometry of an antenna 100 according to a first embodiment of the invention for UWB applications. FIG. 1a is a plan view of the antenna 100. FIG. 1b is a side view of the antenna 100 along line 1-1. FIG. 1c is a back view of the antenna 100 and FIG. 1d is the plan view of the antenna 100 superimposed on the back view.

The antenna 100 is formed on a first surface 104 of a substrate 102, for example a printed circuit board (PCB) made of dielectric materials such as FR4, Rogers 4003 or RT Duroid. The antenna 100 comprises a first radiating element 106 and a second radiating element 108 for transmitting and receiving signals. In this first embodiment of the invention, each of the first and second radiating elements 106, 108 is formed in the shape of a triangle having a planar surface. The first and second radiating elements 106, 108 are symmetrically positioned with respect to a line of symmetry 110 therebetween.

The antenna 100 has a first notch 112 and a second notch 114 formed in the first and second radiating elements 106, 108 respectively. The first and second notches 112, 114 extend from a respective portion of the periphery of the first and second radiating elements 106, 108 and thereinto. In particular, each of the first and second notches 112, 114 is open-ended along respective first edges 132, 134 of the first and second radiating elements 106, 108 and substantially segregates each of the first and second radiating elements 106, 108 into respective two portions 116, 118 and 122, 124 connected by respective interconnecting portions 120, 126. The first and second notches 112, 114 are preferably but not limited to inwardly facing each other and having a substantially elongated shape. The periphery of the first and second radiating elements 106, 108 has a triangular shape but can be of any other geometrical shapes.

A first feeding structure 128 or feed strip is connected along a second edge 136 of the first radiating element 106 while a second feeding structure 130 or feed strip is connected along a second edge 138 of the second radiating element 108. Examples of the first and second feed strips 128, 130 include a co-planar waveguide (CPW), a co-planar stripe (CPS) and a coaxial cable.

The second edges 136, 138 are adjacent to one end of the first edges 132, 134 respectively. Each of the first and second radiating elements 106, 108 has a third edge 140, 142 that interconnects the first 132, 134 and second 136, 138 edges thereof. The first and second radiating elements 106, 108 and the first and second feed strips 128, 130 are arranged as such to achieve pattern diversity.

The first and second feed strips 128, 130 preferably extend outwardly from the second edges 136, 138 of the first and second radiating elements 106, 108 respectively, in a substantially 45° and 135° configuration with respect to the line of symmetry 110 as shown in FIG. 1a. Specifically, each of the first and second feed strips 128, 130 is substantially orthogonal to the respective second edges 136, 138 of the first and second radiating elements 106, 108 and substantially parallel to the respective first and second notches 112, 114. This is so that the polarization direction of each radiating element 106, 108 is orthogonal to each other and substantially parallel to the respective notches 112, 114.

Each of the first and second feed strips 128, 130 further extends towards a first edge 144 of the substrate 104. The first and second feed strips 128, 130 are preferably configured for facilitating connection to respective first and second feeds (not shown) via respective first and second feeding terminals or ports 146, 148. An example of the first and second feeds is a co-axial probe. Each of the first and second feed strips 128, 130 is preferably but not limited to, for example a 50Ω micro-strip line. The first and second feed strips 128, 130 are preferably formed on the first surface 104 of the substrate 102.

A first stub 150 and a second stub 152 are formed on the first and second feed strips 128, 130 respectively for impedance matching purposes. Each of the first and second stubs 150, 152 is preferably formed proximal to the respective second edges 136, 138 of the first and second radiating elements 106, 108.

As illustrated in FIG. 1c, a ground plane 154 is preferably formed on a second surface 156 of the substrate 102. The second surface 156 is outwardly opposite to the first surface 104 of the substrate 102. The ground plane 154 has a central strip 158 extending from one portion thereof to a second edge 160 of the substrate 102 opposite the first edge 144 of the substrate 102. The ground plane 154 and in particular the central strip 158 reduces mutual coupling between the first and second radiating elements 106, 108 on the first surface 104 of the substrate 102. The ground plane 154 is geometrically shaped such that it does not overlap with the first and second radiating elements 106, 108 and has a geometrical shape not limited to the shape as shown in FIG. 1c.

Additionally, the first and second feeds are preferably connected to the first and second feeding terminals 146, 148 respectively as well as to the ground plane for transmitting and receiving the signals.

Each of the first and second notches 112, 114 formed respectively in the first and second radiating elements 106, 108 advantageously creates an electrical current path through which signals having UWB bandwidths travel. In addition, each of the first and second notches 112, 114 helps to concentrate electrical currents within the respective first and second radiating elements 106, 108, especially at the lower operating frequencies. As a result, the effect of the ground plane 154 and the first and second feeds on the impedance matching and radiation performance of the antenna 100 is minimized. The operating frequency bandwidth and impedance response characteristics of the antenna 100 are modifiable by respectively varying the dimensions and configuration of the first and second notches 112, 114 and the first and second radiating elements 106, 108.

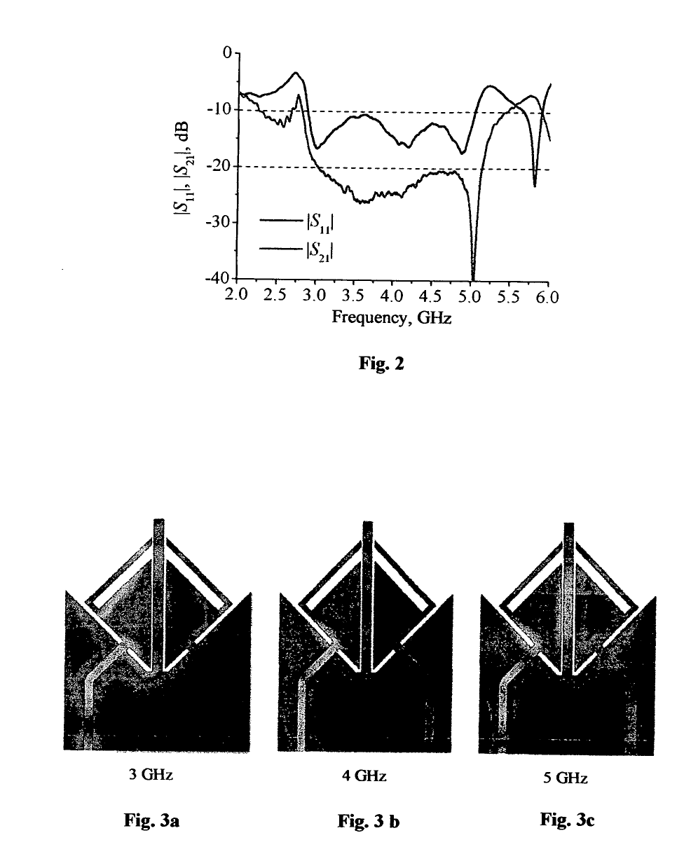

FIG. 2 shows the measured impedance performance of the antenna 100. The measured results show the antenna 100 having a well-matched impedance matching characteristic achieving good return loss |S₁₁|<−10 dB throughout the frequency range of 3.1 GHz to 5 GHz and good isolation |S₂₁|<−20 dB over the same frequency range.

FIGS. 3a to 3c show the current distributions on the antenna 100 at operating frequencies of 3, 4 and 5 GHz respectively. The current, which is in lighter shade, is mostly concentrated around the first 106 or second 108 notch and the central strip 158 of the ground plane 154 instead of the other parts of the ground plane 154, especially at the lower frequency of 3 GHz. This allows the antenna 100 to consist of two radiating elements and yet maintains operational at the lower edge of the operating frequency at 3.1 GHz. Additionally, since there is a small current present in the ground plane 154, mutual coupling between the first and second radiating elements 106, 108 is significantly reduced.

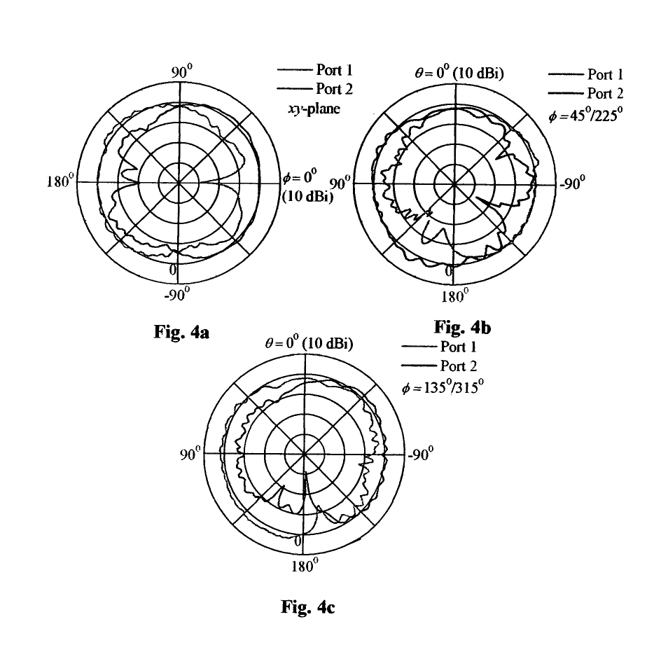

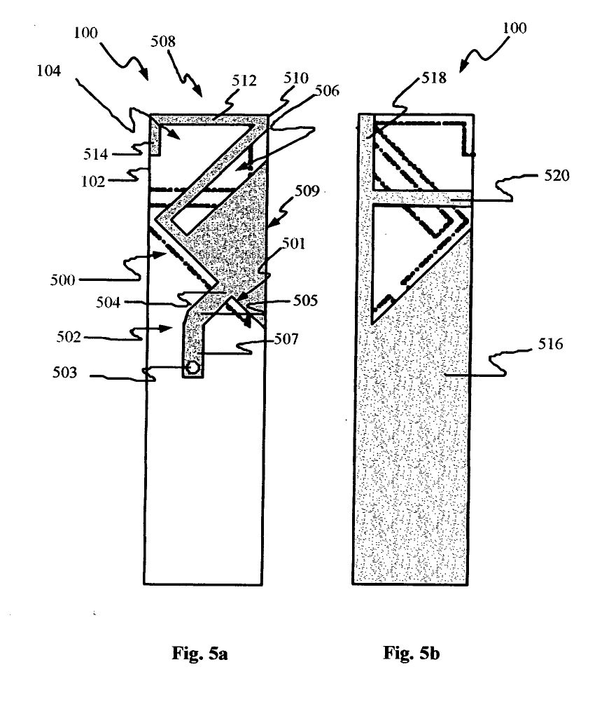

FIG. 4 shows radiation patterns of the antenna 100 measured at 4 GHz and across three principal planes, namely the x-y plane of FIG. 4a, the φ=45°/225° plane of FIG. 4b and the φ=135°/315° plane of FIG. 4c. During measurements, the second terminal 148 of the antenna 100 is terminated with a 50Ω load when the first terminal 146 of the antenna 100 is excited, and vice versa. The graphs of FIGS. 4a to 4c shows the radiation patterns at the three principal planes when the first and second terminals 146, 148 are respectively excited cover complementary spatial regions.

The degree of pattern overlap or correlation ρ is represented by the following equation:

$$ρ = \frac{{\sum }_{n = 1}^{N} {G}_{P 1} ( {θ}_{n} , {φ}_{n} ) {G}_{P 2} ( {θ}_{n} , {φ}_{n} )}{\sqrt{{\sum }_{n = 1}^{N} {G}_{P 1}^{2} ( {θ}_{n} , {φ}_{n} ) {\sum }_{n = 1}^{N} {G}_{P 2}^{2} ( {θ}_{n} , {φ}_{n} )}}$$

where N is the number of data points, G_{P1} and G_{P2} represent the magnitude of the gain response at the first and second terminals 146, 148 respectively, θ and φ are angles of direction formed with reference to the z axis and x-y plane respectively. For pattern diversity, ρ should have a value less than 0.7 in order to achieve good diversity gain. At the operating frequency of 4 GHz, the value of ρ at each of the three principal planes is about 0.4. This demonstrates that the antenna 100 is suitable to be used for diversity applications.

The performance of the antenna 100 is directly related to the structural dimensions thereof. With reference to FIG. 1d, antenna parameters f, g, and l_{g} affect the impedance matching, l, and lₛ determine the lower edge of the operating frequency range, and s, d, and l_{g} control the mutual coupling.

FIGS. 5a and 5b show a front view and a back view of the antenna 100 formable on the first and second surfaces 104, 156 of the substrate 102 respectively, according to a second embodiment of the invention. The antenna 100 comprises a radiating element 500 for transmitting and receiving signals for UWB applications, similar to the first embodiment of the invention. The radiating element 500 has a feeding structure 502 connected and substantially orthogonal thereto. The radiating element 500 and the feeding structure 502 are preferably formed on the first surface 104 of the substrate 104.

The feeding structure 502 has a feeding point 504 preferably positioned proximal to a first side 501 of the radiating element 500. The radiating element 500 has a notch 506 formed therein. The notch 506 extends from a portion of the periphery of the radiating element 500 and into the radiating element 500, wherein the periphery of the radiating element 500 can be of any shape. The notch 506 is therefore open-ended along a second side 509 of the radiating element 500. The notch 506 is geometrically shaped and is preferably substantially elongated.

The feeding structure 502 has a first portion 505 that extends outwardly from the radiating element 500, substantially orthogonal to a first side 501 of the radiating element 500 where the feeding point 504 resides, as shown in FIG. 5a. The feeding structure 502 is preferably configured for facilitating connection of the radiating element 500 to a feed 503. The feeding structure 502 is preferably but not limited to, for example a 50Ω micro-strip line. The feeding structure 502 has a second portion 507 that extends from the first portion 505 and substantially parallel to the longitudinal length of the substrate 102.

In this second embodiment of the invention as shown in FIGS. 5a and 5b, the radiating element 500 has an arm 508 that extends from a top corner 510 of the radiating element 500. The arm 508 has a first section 512 that is connected to the top corner 510 of the radiating element 500 substantially proximal to the portion of the periphery of the radiating element 500 wherefrom the notch 506 extends. The arm 508 further has a second section 514 extending substantially perpendicularly from the free end of the first section 512.

With reference to FIG. 5b, a ground plane 516 is preferably formed on the second surface 156 of the substrate 102. The ground plane 516 has a vertical strip 518 as well as a horizontal strip 520 extending substantially perpendicularly from the vertical strip 516. The vertical strip 516 is used to control the impedance matching performance of the antenna 100.

The ground plane 516 has a geometrical shape not limited to that shown in FIG. 5b. The feed 503 is preferably connected at one terminal to the feeding structure 502 and the other terminal to the ground plane 516 for transmitting and receiving the signals.

Similar to the first embodiment of the invention, the radiating element 500 with the notch 506 advantageously creates an electrical current path through which signals having UWB bandwidths travel. As with the first embodiment of the invention, the presence of the notch 506 helps to concentrate the electrical current within the radiating element 500 instead of the ground plane 516, especially at the lower operating frequencies. Therefore, the effect of the ground plane 516 and the feed 503 on the impedance matching and radiation performance of the antenna 100 is substantially minimized. The operating frequency bandwidth and impedance response characteristics of the antenna 100 are modifiable by respectively varying the dimensions and configuration of the notch 506 and the radiating element 500.

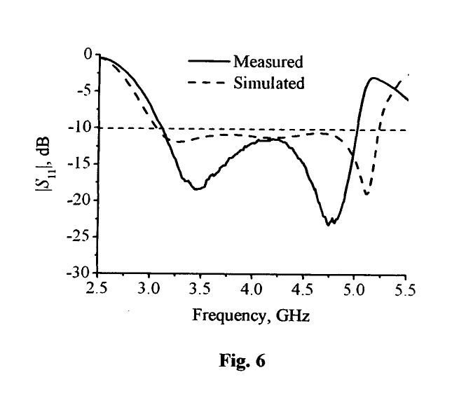

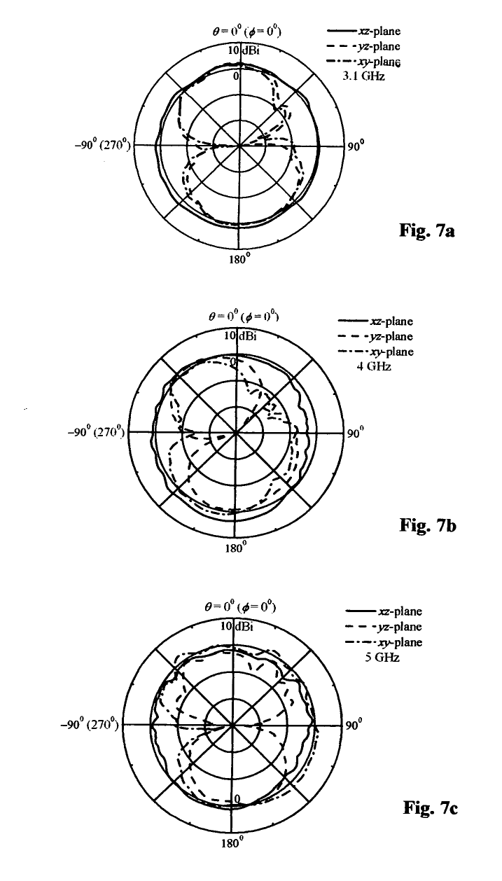

FIG. 6 is a graph showing measured and simulated results of the impedance matching of the antenna 100 of FIG. 5a in good agreement. The impedance matching frequency response of the antenna 100 is represented by |S₁₁|. The measured and simulated results show the antenna 100 having a well-matched impedance matching characteristic throughout the frequency range of 3.1 GHz to 5 GHz and achieving good return loss |S₁₁| of less than −10 dB over the same frequency range.

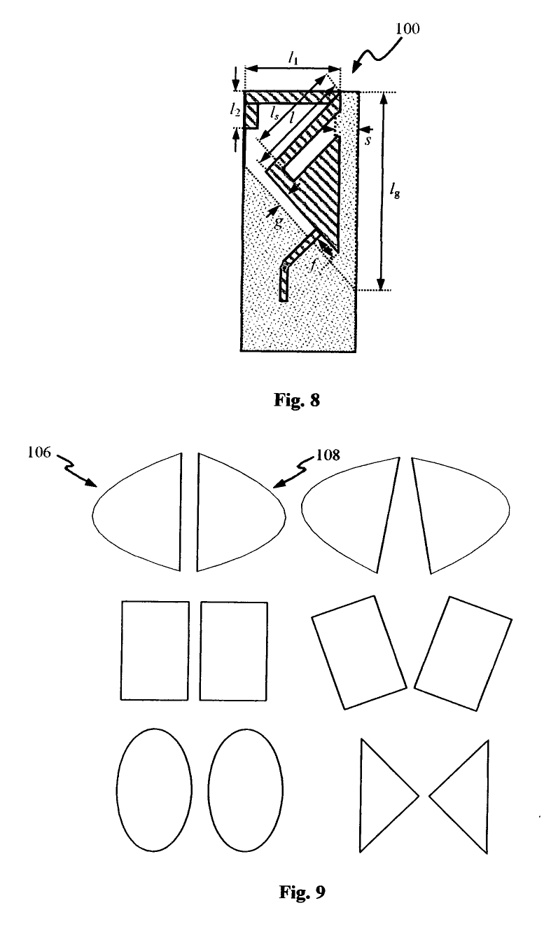

FIGS. 7a to 7c show measured co-polarized radiation patterns of the antenna 100 of FIG. 5a across three main planes, namely the x-z plane, the y-z plane, and the x-y plane, respectively. The radiation patterns are co-polarized across each of the three main planes are measured at three different frequencies, namely 3.1, 4 and 5 GHz. The co-polarized radiation patterns show that the radiation from the antenna 100 is omni-directional across the impedance bandwidth.

FIG. 8 shows the plane view of the antenna 100 of FIG. 5a superimposed with the back view of the antenna 100 of FIG. 5b. The performance of the antenna 100 is directly related to the structural dimensions thereof. With reference to FIG. 8, antenna parameters f, g, and l_{g} affect the impedance matching l, lₛ, l₁, and l₂ determine the lower edge of the operating frequency range for miniaturizing the antenna 100.

In another aspect of the above-described embodiments of the invention, the radiating elements 106, 108, 500 have a geometrical shape not being limited to rectangular, elliptical, semi-elliptical or triangular, as shown in FIG. 9. The radiating elements 106, 108, 500 can be orientated towards any direction. In the case of the first embodiment of the invention, the first and second radiating elements 106, 108 are arranged on the same first side 104 of the substrate 102 and are symmetrically displaced about the line of symmetry 110. As such, the shape of the first and second notches is dependable on the shape or orientation of the radiating elements.

The antenna 100 is advantageously able to achieve a broad impedance bandwidth of 3.1 to 5 GHz or 6 to 10.6 GHz with good gain and radiation performance. The antenna 100 is also sufficiently miniaturized for use in wireless USB dongles or thumb drives and other portable mobile devices.

In the foregoing manner, an antenna for UWB applications is disclosed. Although only a number of embodiments of the invention are disclosed, it becomes apparent to one skilled in the art in view of this disclosure that numerous changes and/or modifications can be made without departing from the scope and spirit of the invention.

1. An antenna for ultra wideband applications, the antenna comprising:
a first radiating element shaped for defining a first notch, the first radiating element having a first feeding structure; and
a second radiating element operatively couplable to the first radiating element and shaped for defining a second notch, the second radiating element having a second feeding structure, the first and second feeding structures being substantially orthogonal to each other and the first and second radiating elements having an inter-displacement,
wherein the first radiating element and the first feeding structure is substantially symmetrical to the second radiating element and the second feeding structure respectively about a line of symmetry passing through the inter-displacement between the first and second radiating elements for achieving orthogonal polarization and radiating pattern diversity between the first and second radiating elements.

2. The antenna of claim 1, wherein the first notch extends substantially parallel to the first feeding structure and the second notch extends substantially parallel to the second feeding structure.

3. The antenna of claim 1, wherein each of the first and second notches has an opening, the opening of the first notch facing inwardly the opening of the second notch.

4. The antenna of claim 1, wherein the first and second radiating elements are formed on a surface of a substrate.

5. The antenna of claim 1, wherein a ground plane is formed on another surface of the substrate opposite to the surface on which the first and second radiating elements are formed.

6. The antenna of claim 5, wherein each of the first and second radiating elements does not overlap with the ground plane.

7. The antenna of claim 5, wherein the ground plane has a central strip extending in between the first and second radiating elements for reducing mutual coupling between the first and second radiating elements.

8. The antenna of claim 1, further comprises an arm extending from the second portion of the first radiating element.

9. The antenna of claim 8, wherein the arm extends substantially outwardly from the second portion of the first radiating element.

10. The antenna of claim 8, wherein the arm has a first section and a second section, one end of the first section being connected to the second portion of the radiating element and the second section being extended perpendicularly from the other end of the first section.

11. A method for configuring an antenna comprising:
providing a first radiating element shaped for defining a first notch, the first radiating element having a first feeding structure; and
providing a second radiating element operatively couplable to the first radiating element and shaped for defining a second notch, the second radiating element having a second feeding structure, the first and second feeding structures being substantially orthogonal to each other and the first and second radiating elements having an inter-displacement,
wherein the first radiating element and the first feeding structure is substantially symmetrical to the second radiating element and the second feeding structure respectively about a line of symmetry passing through the inter-displacement between the first and second radiating elements for achieving orthogonal polarization and radiating pattern diversity between the first and second radiating elements.

12. The method of claim 11, providing the first and second radiating elements further comprising forming the first notch extends substantially parallel to the first feeding structure and the second notch extends substantially parallel to the second feeding structure.

13. The method of claim 12, further comprising forming an opening in each of the first and second notches, the opening of the first notch facing inwardly the opening of the second notch.

14. The method of claim 12, further comprising forming the first and second radiating elements on a surface of a substrate.

15. The method of claim 14, further comprising forming a ground plane on another surface of the substrate opposite to the surface on which the first and second radiating elements are formed.

16. The method of claim 15, wherein each of the first and second radiating elements are formed without overlapping with the ground plane.

17. The method of claim 16, further comprising extending a central strip from a portion of the ground plane in between the first and second radiating elements for reducing mutual coupling between the first and second radiating elements.

18. The method of claim 11, further comprising extending an arm from the second portion of the first radiating element.

19. The method of claim 18, wherein extending an arm from the second portion of the first radiating element comprises extending the arm substantially outwardly from the second portion of the first radiating element.

20. The method of claim 18, wherein the arm has a first section and a second section, one end of the first section being connected to the second portion of the radiating element and the second section being extended perpendicularly from the other end of the first section.
